(19) United States
(12) Patent Application Publication
(10) Pub. No.: US 2015/0006258 A1
(43) Pub. Date: Jan. 1, 2015

(54) SUBSCRIPTION-BASED MOBILE READING PLATFORM

(71) Applicant: Studio SBV, Inc., New York, NY (US)

(72) Inventors: Rafik Salama, Brooklyn, NY (US); Matthew Joseph Shatz, New York, NY (US); Cameron Nelson Spickert, New York, NY (US); Eric Stromberg, New York, NY (US); Vivek H. Patel, Yorktown Heights, NY (US); Andrew Brown, New York, NY (US); Rohith Salim, New York, NY (US); Willem Paul Van Lancker, New York, NY (US)

(73) Assignee: Studio SBV, Inc., New York, NY (US)

(21) Appl. No.: 14/213,119

(22) Filed: Mar. 14, 2014

Related U.S. Application Data
(60) Provisional application No. 61/787,575, filed on Mar. 15, 2013.

(51) Int. Cl. G06Q 30/02

(52) U.S. Cl. CPC G06Q 30/0206
USPC 705/7.35

(57) ABSTRACT

The disclosed invention relates subscription based electronic book reading platform for mobile devices. In embodiments, the reading platform may provide recommendations of electronic books to users based on a user's behavior. In embodiments, the reading platform may provide for methods which determine lifetime value of books and payment to content providers within a subscription based electronic book service model. The reading platform may also restrict user access depending on user location or connection.

### CROSS-REFERENCE TO RELATED APPLICATIONS

The present application claims the benefit of U.S. Provisional Application Ser. No. 61/787,575 filed Mar. 15, 2013, which is incorporated herein by reference in its entirety.

### BACKGROUND

1. Field

The methods and systems described herein relate to a hosting platform for a subscription-based electronic book service.

2. Description of Related Art

With the increased popularity and sophistication of personal mobile devices, there is an increased demand for media content available for personal mobile devices. Electronic book readers, or eReaders, are an increasingly popular classification of personal mobile devices. Even electronic devices not known traditionally as eReaders, such as smartphones and laptops, are programmed with functionality similar to that of eReaders. Several reading platforms exist in the art that allow users to install applications or programs on their mobile device to access digital media. In particular, books have made a significant transition from print to digital in order to satisfy the demands and capabilities of consumers. The reading platforms that currently exist in the art allow users to view and interact with books and other published content, though on a very basic level. Users may read the words on the pages and in some instances make notes. Currently, users may also interact with other users in order to discuss books users are reading or to discover new content. There exists a need in the art, however, of a more sophisticated method of consuming digital content. Consumers currently lack an ability to seamlessly access content while discovering new content in an organic environment that is unique to each user. Consumers and publishers alike lack methods of finding common ground, in order to provide the best content possible while still generating the most value for each individual user. The methods and systems disclosed herein address such needs.

### SUMMARY OF THE INVENTION

Provided herein are methods and systems for providing recommendations based on in-book reading activity in a subscription based electronic book business model. The method include providing a database of electronic books and allowing a user's content viewing device to access the database of electronic books. The method may further include monitoring the user's in book reading activity. Additionally, the method may include generating recommendations based on the user's in-book reading activity.

Also provided herein are methods and systems for a lifetime value model for a book to determine publisher value in a subscription based electronic book business model. The model may include providing a database of electronic books, wherein the database comprises electronic content aggregated from a plurality of electronic content owners. The model may additionally include allowing a user's content viewing device to access the database of electronic books. Further, the model may include collecting subscription fees for allowing a user's content viewing device to access the database of electronic books. The model may also include aggregating the subscription fees via a content owner payment facility. The model may include determining a content owner's payment via a lifetime value calculator and distributing a content owner's payment based on the determination.

Further provided herein are systems and methods for determining a dynamic sample reading percentage or threshold for a publisher's payment. The determination may include first providing a database of electronic books, wherein the database comprises electronic content aggregated from a plurality of electronic content owners. The determination may also include allowing a user's content viewing device to access the database of electronic books. The determination may include collecting subscription fees for allowing a user's content viewing device to access the database of electronic books. Additionally, the determination may include aggregating the subscription fees into a subscription fee pool via a subscription fee pool use allocator. The method may include determining a content owner's payment which may be funded by the subscription fee pool via a publisher payment calculator, wherein the publisher payment calculator comprises a sale trigger determination function and then distributing a content owner's payment based on the determination.

The methods and systems disclosed herein may comprise a pricing module for clearing wholesale and retail pricing of electronic books where wholesale and retail pricing are not determined using the same unit basis. The pricing module may include providing a database of electronic books and allowing a user's content viewing device to access the database of electronic books. The pricing module may further include restricting user access to content within the database of electronic books and allowing user access to restricted content based on a user's network connection information.

The methods and systems disclosed herein may comprise a method for providing subscription tiers and content restrictions. The methods and systems disclosed herein may provide for conditional access to a full electronic book based on location relative to a partner facility or network. This method may include providing a database of electronic books and allowing a user's content viewing device to access the database of electronic books. The method may additionally include dividing a user-selected book into a plurality of sequential sections and transmitting a first section to a user's content viewing device. The method may include displaying the first section on a user's content viewing device and transmitting the remaining sections in sequential order.

The methods and systems disclosed herein may provide for a method for electronic book distribution with access terms based on location. Disclosed herein are methods and systems which may provide for a web kit based electronic book reader facilitating one click reading on a mobile device. Additionally, disclosed herein are methods and systems which may provide for vertical scrolling view of an electronic book on a mobile device based electronic book reader, including vertical pagination of the electronic book. The methods and systems disclosed herein may provide for a publisher analytics portal which generates analytics based on in-book reader activity. The methods and systems disclosed herein may provide for the generation of analytics based on a combination of reader behavior and supporting data. Further provided are methods which include controlling user reading speed/jumping based on tracking extent of content read in an electronic book reader and passive book list generation based on observed reading behavior.

In accordance with various illustrative but non-limiting embodiments, the systems and methods disclosed herein may include a method of determining a lifetime value of a book. The method may include taking a reading prediction model that predicts reader reading activity for the book based on at least two of customer ratings, critic ratings, retail pricing, wholesale pricing, print pricing, and electronic pricing, the population of the reading prediction model. The method may then include aggregating data from a plurality of social media sources associated with the book and aggregating user reading activity for the book across a plurality of subscribers using an electronic book reading platform. The method may further include using a valuation model to calculate the expected lifetime value for the book, wherein the expected lifetime value is based on at least one of the price for reading within the book, the price of the book, the reading prediction model and the cost of offering the book. In embodiments, the data from the plurality of social media sources may include trending data. In embodiments, the data may be associated with popularity of the book may include liking data. In embodiments, the calculated expected lifetime value may be based on trending data. In embodiments, the calculated expected lifetime value may be based on liking data, critic reviews, or book price. In embodiments, the data from the plurality of social media sources may include social media data. In embodiments, the calculated expected lifetime value may be based on metrics derived from external book-related behavior or on metrics derived from a user's book-related behavior. In embodiments, the metrics derived from a user's book-related behavior may include reading progress. In embodiments, a user's reading progress is determined by using user view-page boundary words. In embodiments, determining the user view-page boundary words includes taking a page size attribute of a user's content viewing device, determining an amount of viewable content for the page size, taking a first word of a section of an electronic book, calculating a page last word for a plurality of sequential pages of the electronic book based on the determined amount of viewable content and content in the section that follows the first word, and based on page last word information gathered when a page is viewed during a reading session, and then determining an extent of user reading of the electronic book during and across reading sessions. In embodiments, user reading activity may include an amount of the book the user has read. In embodiments, the method may include distributing subscription fees to content owners based on the expected lifetime value via a publisher payment facility. The method may include generating a recommendation for a user based on a book's expected lifetime value. The method may also include determining an impact of the calculated expected lifetime value on how much a content owner of the book is paid, and adjusting at least one upcoming content owner payment based on the calculated expected lifetime value. In embodiments, aggregating user reading activity for the book across a plurality of subscribers using an electronic book reading platform is adjusted based on an anticipated reader churn rate for the subscribers. The reading prediction model may predict reader reading activity based on an anticipated reader churn rate for subscribers using the electronic book reading platform.

In accordance with various illustrative but non-limiting embodiments, the systems and methods disclosed herein may include a method including aggregating user viewing activity for a book across a sample group of subscribers to an electronic book reading platform, measuring the amount of time the sample group of subscribers spend reading the book, then, based at least in part on the sample group, projecting the amount of time a population of subscribers other than the sample group is expected to spend reading the book, and calculating the expected lifetime value for the book, wherein the expected lifetime value is based on at least one of the price for reading within the book, the price of the book, the projected amount of time and the cost of the book. In embodiments, projecting may include accounting for at least one of a demographic factor, an age factor, a gender factor, a psychographic factor and a location factor.

In accordance with various illustrative but non-limiting embodiments, the systems and methods disclosed herein may include a method including aggregating user viewing activity for a book across a sample group of subscribers to an electronic book reading platform. The method may also include measuring at least one of a churn rate and an abandonment rate for subscribers using the book over a first period of time, determining an impact of at least one of the churn rate and the abandonment rate on an estimated amount of time subscribers will spend reading the book over a second period of time, and determining an aggregate subscriber reading time estimate for the second period of time to determine a lifetime impact of at least one of subscriber churn and subscriber abandonment.

In accordance with various illustrative but non-limiting embodiments, the systems and methods disclosed herein may include a method that includes calculating a lifetime value of a plurality of content owner-specific books in a subscription-based electronic book reading platform and comparing the calculated lifetime values for a plurality of content owners. The method may also include, based on the comparison, determining a portion of a subscription pool credit for the content owner. In embodiments, the subscription pool may include subscription revenue collected from readers of the book. In embodiments, determining a portion of a subscription pool may include calculating a number of times content for the content-owner is consumed dividing the calculated number of times by the total number of content items consumed, and weighing results of the dividing with a comparable wholesale pricing factor for the book.

In accordance with various illustrative but non-limiting embodiments, the systems and methods disclosed herein may include a method including providing a collection of electronic books, wherein the collection may include electronic content aggregated from a plurality of electronic content owners, allowing a user's content viewing device to access the collection of electronic books, collecting subscription fees for allowing a user's content viewing device to access the collection of electronic books, aggregating the subscription fees via a payment facility, determining a content owner's share of subscription fees to be distributed to content owners based a lifetime value calculator for the content owner's content, and distributing a content owner's share of subscription fees based on the determination. In embodiments, allowing a user's content viewing device to access the collection of electronic books may include providing an application for executing on the content viewing device that includes a user interface through which a user can view virtual covers of the electronic books. In embodiments, selecting a virtual cover in the user interface causes a selection of a corresponding electronic book. In embodiments, allowing a user's content viewing device to access the collection of electronic books may include presenting virtual covers of the electronic books that facilitate single-click reading of a selected book.

In accordance with various illustrative but non-limiting embodiments, the systems and methods disclosed herein may include an electronic content distribution platform. The platform may include a collection of electronic content aggregated from a plurality of electronic content owners, a content distribution engine, a lifetime value calculating engine for calculating the lifetime value of the electronic content, and a fee distribution engine for distributing fees to content owners based on the lifetime value calculations. In embodiments, lifetime value is based at least in part on user activity within the content. In embodiments, the content is a book and the lifetime value is based at least in part on reading activity of readers within the book. The reading activity of readers within the book may include determining reading progress. In embodiments, a user's reading progress may be determined using user view-page boundary words. In embodiments, determining user view-page boundary words may include taking a page size attribute of a user's content viewing device, determining an amount of viewable content for the page size, taking a first word of a section of an electronic book, calculating a page last word for a plurality of sequential pages of the electronic book based on the determined amount of viewable content and content in the section that follows the first word, and based on page last word information gathered when a page is viewed during a reading session, determining an extent of user reading of the electronic book during and across reading sessions.

In accordance with various illustrative but non-limiting embodiments, the systems and methods disclosed herein may include a method including providing access to a collection of electronic books, allowing a user's content viewing device to access at least on electronic book, monitoring the user's in-book reading activity, and generating a recommendation based on the user's in-book reading activity. In embodiments, allowing a user's content viewing device to access the collection of electronic books may include providing an application for executing on the content viewing device that includes a user interface through which a user can view virtual covers of the electronic books. In embodiments, selecting a virtual cover in the user interface may cause a selection of a corresponding electronic book. In embodiments, allowing a user's content viewing device to access the collection of electronic books may include presenting virtual covers of the electronic books that facilitate single-click reading of a selected book.

In accordance with various illustrative but non-limiting embodiments, the systems and methods disclosed herein may include an electronic content distribution platform including an electronic content collection, wherein the electronic content is stored in a non-transitory storage medium, a content distribution engine that facilitates reader access to the content collecation, an in-book activity monitor that collects reader activities while viewing a book accessed by the content distribution engine, and a recommendation engine that generates recommendations based on data collected by the in-book activity monitor.

In accordance with various illustrative but non-limiting embodiments, the systems and methods disclosed herein may include a method of generating recommendations based on in-book reading activity, the method including collecting explicit actions of a user during reading of an electronic book on a content viewing device via an electronic book access interface of a subscription-based electronic book access platform that may include a collection of electronic books and associated metadata, determining implicit actions of the user based on the user's use of the content viewing device and the electronic book access interface, providing the determined implicit actions of the user and the collected explicit actions of the user to a recommendation engine, and generating a recommendation for a book other than the selected book with the recommendation engine by determining at least one of similarity of the implicit actions of the user and similarity of the explicit actions of the user with actions of other subscribers to the subscription-based electronic book platform. The method may also include accessing book metadata for the selected book and at least one other book in the collection of electronic books with the recommendation engine. The method may also include determining a recommendation at least in part based on similarity of book metadata for the book viewed on the viewing device and another book in the collection. The method may also include determining a user's habits.

In embodiments, the method may also include determining a user's preferences. In embodiments, determining implicit actions of the user may be based on data collected by an in-book activity monitor of the subscription-based electronic book platform. In embodiments, data collected by the in-book activity monitor may include at least one of where a user pauses, where a user stops reading, where a reader reads fast, time of the reader's session, user annotations, number of pages read, user ratings, and user shares. The method may include providing a user's demographic information to a recommendation engine. In embodiments, the number of pages read may be determined by user view-page boundary words. In embodiments, determining user view-page boundary words may include taking a page size attribute of a user's content viewing device, determining an amount of viewable content for the page size, taking a first word of a section of an electronic book, calculating a page last word for a plurality of sequential pages of the electronic book based on the determined amount of viewable content and content in the section that follows the first word, and based on page last word information gathered when a page is viewed during a reading session, determining an extent of user reading of the electronic book during and across reading sessions. The method may include analyzing user demographic information to generate a recommendation. In embodiments, demographic information may include at least one of user age, gender, location, profession, socioeconomic status, and education. In embodiments, determining implicit actions of the user may be based on at least one of a user's browsing habits, books that user does not select, rereading sections, stopping a book after a certain number of chapters, and how long it takes a user to return to a book after the user has stopped reading. In embodiments, the book metadata may include substantive traits of books, which may include at least one of length of chapters, subject matter, writing style, publication date, total page number, publisher, genre, author, and rating. In embodiments, the method may include providing the recommendation to the user. The recommendation may be provided to a user when user in-book reading activity indicates that the user is close to finishing reading the selected book, when a publisher announces a new book, when a user has paused reading a book for a predetermined amount of time, or when a publisher is interested in gathering user input regarding books to publish. In embodiments, generating a recommendation may include analyzing at least one of the user adding a book to a list, the user sharing a book, viewing a book synopsis, reading a review of a book, the actions of a user's social network contacts, the reaction of a user's contacts to reading a book, and a user's friends activities while using the reading.

In accordance with various illustrative but non-limiting embodiments, the systems and methods disclosed herein may include a method including providing a collection of electronic books, wherein the collection may include electronic content aggregated from a plurality of electronic content owners, allowing a user's content viewing device to access the collection, collecting subscription fees for allowing a user's content viewing device to access the collection, aggregating the subscription fees into a subscription fee pool via a subscription fee pool share allocator, determining a content owner's share of the subscription fee pool via a publisher percentage share calculator, wherein the publisher percentage share calculator may include a sale trigger determination function, and distributing a content owner's share of the subscription fee pool based on the determination. In embodiments, allowing a user's content viewing device to access the collection of electronic books may include providing an application for executing on the content viewing device that includes a user interface through which a user can view virtual covers of the electronic books. In embodiments, selecting a virtual cover in the user interface causes a selection of a corresponding electronic book. In embodiments, allowing a user's content viewing device to access the collection of electronic books may include presenting virtual covers of the electronic books that facilitate single-click reading of a selected book.

In accordance with various illustrative but non-limiting embodiments, the systems and methods disclosed herein may include an electronic content distribution platform including an electronic content collection wherein the collection may include electronic content aggregated from a plurality of electronic content owners, a content distribution engine, an in-book activity monitor that monitors activity of a reader within an electronic book from the collection; a fee triggering engine that triggers a fee when a threshold activity level is met within the in-book activity monitor, and a fee distribution engine for distributing the fee to a content owner based on the triggering of the fee.

In accordance with various illustrative but non-limiting embodiments, the systems and methods disclosed herein may include a method of dynamically determining a reading percentage trigger for publisher payment, including providing a collection of electronic books, wherein the collection may include electronic content aggregated from a plurality of electronic content owners, allowing a user's content viewing device to access the collection of electronic books, collecting subscription fees for allowing a user's content viewing device to access the collection of electronic books, aggregating the subscription fees into a subscription fee pool via a subscription fee pool share allocator, monitoring the user's in-book reading activity; and determining a content owner's share of the subscription fee pool via a publisher percentage share calculator that processes the monitored user in-book reading activity with a sale trigger determination function. In embodiments, the sale trigger determination function may determines the owner's share of the subscription fee pool based on a user's monitored reading activity. In embodiments, a user's monitored reading activity may include reading progress, which may be determined using user view-page boundary words. In embodiments, determining user view-page boundary words my include taking a page size attribute of a user's content viewing device, determining an amount of viewable content for the page size, taking a first word of a section of an electronic book, calculating a page last word for a plurality of sequential pages of the electronic book based on the determined amount of viewable content and content in the section that follows the first word, and based on page last word information gathered when a page is viewed during a reading session, determining an extent of user reading of the electronic book during and across reading sessions. In embodiments, the sale trigger determination function may determine the owner's share of the subscription fee pool based on the percentage of content viewed by the user, the owner's share of the subscription fee pool based on the subscription status of the user, or the owner's share of the subscription fee pool based on external factors. In embodiments, the external factors may include whether the content was referred to the user by a different user. In embodiments, the sale trigger determination function may determine the owner's share of the subscription fee pool based on the user's information, device type, device settings or aggregated user habits. In embodiments, allowing a user's content viewing device to access the collection of electronic books may include providing an application for executing on the content viewing device that includes a user interface through which a user can view virtual covers of the electronic books. In embodiments, selecting a virtual cover in the user interface may cause a selection of a corresponding electronic book. In embodiments, allowing a user's content viewing device to access the collection of electronic books may include presenting virtual covers of the electronic books that facilitate single-click reading of a selected book.

In accordance with various illustrative but non-limiting embodiments, the systems and methods disclosed herein may include A method of dynamically determining a reading percentage trigger for publisher payment, including providing a collection of electronic books, wherein the collection may include electronic content aggregated from a plurality of electronic content owners, allowing at least one content viewing device of a user to access the collection of electronic books, taking a first payment trigger reading percentage threshold and determining a first reading corresponding point in a user selected book, determining a second reading corresponding point in the selected book based on at least one of user subscription type, publisher pricing model, referral status of the selected book, user content viewing device settings, and user demographics, and triggering a publisher payment activity when monitored in-book user reading activity indicates that the user reading the selected book reaches at least one of the first and second reading corresponding points. In embodiments, the second reading corresponding point may be a user-specific point. In embodiments, a second reading corresponding point for a second user having selected the same user selected book as the user, is different than the second reading corresponding point for the user.

In accordance with various illustrative but non-limiting embodiments, the systems and methods disclosed herein may include a method of dynamically determining a reading percentage trigger for publisher payment, including providing a collection of electronic books, wherein the collection may include electronic content aggregated from a plurality of electronic content owners, allowing a plurality of user content viewing devices to access the collection of electronic books, monitoring in-book reading activity of a user using the plurality of user content viewing devices to read a user selected book, and triggering a publisher payment activity when monitored in-book user reading activity aggregated across the plurality of user content viewing devices indicates that the user reading the selected book has reached a payment trigger reading percentage. In embodiments, the aggregated in-book user activity may include reader progress. In embodiments, wherein a user's reading progress may be determined using user view-page boundary words. In embodiments, determining user view-page boundary words may include taking a page size attribute of a user's content viewing device, determining an amount of viewable content for the page size, taking a first word of a section of an electronic book, calculating a page last word for a plurality of sequential pages of the electronic book based on the determined amount of viewable content and content in the section that follows the first word, and based on page last word information gathered when a page is viewed during a reading session, determining an extent of user reading of the electronic book during and across reading sessions.

In accordance with various illustrative but non-limiting embodiments, the systems and methods disclosed herein may include a method including taking a page size attribute of a user's content viewing device, determining an amount of viewable content for the page size, taking a first word of a section of an electronic book, calculating a page last word for a plurality of sequential pages of the electronic book based on the determined amount of viewable content and content in the section that follows the first word, and based on page last word information gathered when a page is viewed during a reading session, determining an extent of user reading of the electronic book during and across reading sessions.

In accordance with various illustrative but non-limiting embodiments, the systems and methods disclosed herein may include a method including taking a publisher page size attribute for an electronic book, determining an amount of page-specific viewable content based on the publisher page size attribute, identifying a page first word and a page last word for a plurality of sequential publisher page size pages of the electronic book, detecting when a page-specific page first word is viewed by a reader of the electronic book, detecting when a page-specific page last word is viewed by the reader, calculating a whole number of pages viewed by the reader during a reading session by counting the page-specific page last words viewed by the reader, and making the calculated whole number of pages viewed available to a publisher payment determination calculation facility.

In accordance with various illustrative but non-limiting embodiments, the systems and methods disclosed herein may include a method of dynamically determining a reading percentage trigger for publisher payment, including providing a collection of electronic books, wherein the collection may include electronic content aggregated from a plurality of electronic content owners, allowing a user's content viewing device to access the collection of electronic books, monitoring the user's in-book reading activity, determining the first and last portion of the electronic book read by a user, storing the first and last portions of the electronic book read by the user, determining the percentage of a book read based on the stored first and last portions of the electronic book used, and using the determined percentage of a book read to determine whether a threshold requirement to trigger a content owner payment has been met. In embodiments, allowing a user's content viewing device to access the collection of electronic books may include providing an application for executing on the content viewing device that includes a user interface through which a user can view virtual covers of the electronic books.

In embodiments, selecting a virtual cover in the user interface may cause a selection of a corresponding electronic book. In embodiments, allowing a user's content viewing device to access the collection of electronic books may include presenting virtual covers of the electronic books that facilitate single-click reading of a selected book.

In accordance with various illustrative but non-limiting embodiments, the systems and methods disclosed herein may include a method including providing a collection of electronic books, allowing a user's content viewing device to access the collection of electronic books and determining the user's in-book reading activity wherein the determination is based on determining a first plurality of words at the beginning of the user's view, determining a second plurality of words at the end of the user's view, and determining a match of the first plurality of words and second plurality of words within the collection of electronic books. In embodiments, allowing a user's content viewing device to access the collection of electronic books may include providing an application for executing on the content viewing device that includes a user interface through which a user can view virtual covers of the electronic books. In embodiments, selecting a virtual cover in the user interface may cause a selection of a corresponding electronic book. In embodiments, allowing a user's content viewing device to access the collection of electronic books may include presenting virtual covers of the electronic books that facilitate single-click reading of a selected book.

In accordance with various illustrative but non-limiting embodiments, the systems and methods disclosed herein may include a method including providing a collection of electronic books, allowing a user's content viewing device to access the collection of electronic books, displaying a user selected book via the content viewing device, and determining the location of a user's reading activity within the user selected book wherein the determination is based on the content displayed at the beginning of the content viewing device the content displayed at the end of the content viewing device. In embodiments, allowing a user's content viewing device to access the collection of electronic books may include providing an application for executing on the content viewing device that includes a user interface through which a user can view virtual covers of the electronic books. In embodiments, selecting a virtual cover in the user interface may cause a selection of a corresponding electronic book. In embodiments, allowing a user's content viewing device to access the collection of electronic books may include presenting virtual covers of the electronic books that facilitate single-click reading of a selected book.

In accordance with various illustrative but non-limiting embodiments, the systems and methods disclosed herein may include a method including providing a collection of electronic books, allowing a user's content viewing device to access the collection of electronic books, displaying a user-selected book from the collection of electronic books via the content viewing device, monitoring aspects of user in-book activities including the user's reading progress within the user selected book, and controlling a user's rate of access to pages in the book that have not already been viewed by the user based on aspects of user in-book activities. In embodiments, controlling the user's rate of access to pages may include limiting a rate of navigation to pages that have not already been viewed by the user. In embodiments, aspects of user in-book activities include a measure of the user's reading progress. In embodiments, a user's reading progress may be determined using user view-page boundary words. In embodiments, determining user view-page boundary words may include taking a page size attribute of a user's content viewing device, determining an amount of viewable content for the page size, taking a first word of a section of an electronic book, calculating a page last word for a plurality of sequential pages of the electronic book based on the determined amount of viewable content and content in the section that follows the first word, and based on page last word information gathered when a page is viewed during a reading session, determining an extent of user reading of the electronic book during and across reading sessions. In embodiments, aspects of user in-book activities may include a rate of the user's reading progress over a current reading session or a rate of the user's reading progress over a plurality of reading sessions. In embodiments, controlling the user's rate of access to pages may be further based on a fee received from the user. In embodiments, allowing a user's content viewing device to access the collection of electronic books may include providing an application for executing on the content viewing device that includes a user interface through which a user can view virtual covers of the electronic books. In embodiments, selecting a virtual cover in the user interface causes a selection of a corresponding electronic book. In embodiments, allowing a user's content viewing device to access the collection of electronic books may include presenting virtual covers of the electronic books that facilitate single-click reading of a selected book.

In accordance with various illustrative but non-limiting embodiments, the systems and methods disclosed herein may include method including, providing a collection of electronic books, allowing a user's content viewing device to access the collection of electronic books, providing a page navigation capability that facilitates jumping forward and backward a number of pages of a book, monitoring the user's in-book activity for books accessed by the user's content viewing device, and adjusting the number of pages that a user can jump forward with the navigation capability based on the monitored user's in-book activity. In embodiments, allowing a user's content viewing device to access the collection of electronic books may include providing an application for executing on the content viewing device that includes a user interface through which a user can view virtual covers of the electronic books. In embodiments, selecting a virtual cover in the user interface may causes a selection of a corresponding electronic book. In embodiments, allowing a user's content viewing device to access the collection of electronic books may include presenting virtual covers of the electronic books that facilitate single-click reading of a selected book.

In accordance with various illustrative but non-limiting embodiments, the systems and methods disclosed herein may include a method including monitoring user in-book reading activity for a plurality of subscribers to a subscription-based electronic book serving system while the users are reading electronic books selected from a collection of electronic books through an interface of the subscription-based electronic book serving system generating analytics on the monitored user in-book reading activity that facilitate determining book-specific activity metrics and providing a publisher portal for accessing the monitored user in-book reading activity and the determined book-specific activity metrics. In embodiments, the book-specific activity metrics may be aggregated for a plurality of subscribers and may include users' reading progress. A user's reading progress may be determined using user view-page boundary words. In embodiments, determining user view-page boundary words includes taking a page size attribute of a user's content viewing device, determining an amount of viewable content for the page size, taking a first word of a section of an electronic book, calculating a page last word for a plurality of sequential pages of the electronic book based on the determined amount of viewable content and content in the section that follows the first word, and based on page last word information gathered when a page is viewed during a reading session, determining an extent of user reading of the electronic book during and across reading sessions. In embodiments, the analytics may include grouping subscribers that share similar types of in-book reading activity. In embodiments, the portal may facilitate viewing at least a current reading position of at least one user currently reading an electronic book

In accordance with various illustrative but non-limiting embodiments, the systems and methods disclosed herein may include a method including providing a collection of electronic books, allowing a user's content viewing device to access the collection of electronic books, monitoring the user's in-book reading activity, providing a publisher analytics portal that facilitates publisher access to book-specific analytics based on the monitored in-book user activity; and providing a book content-related recommendation based on the analytics via the publisher analytics portal. In embodiments, the book-specific analytics may be updated in real-time. In embodiments, the publisher analytics portal may include an interactive dashboard. In embodiments, the recommendation provided may include content suggestion or a marketing suggestion. The marketing suggestion may include cover art, placement of a book within a catalogue, or pricing. In embodiments, the recommendation provided may include a determination of the most effective subject matter.

In accordance with various illustrative but non-limiting embodiments, the systems and methods disclosed herein may include a method including providing a collection of electronic books, allowing a user's content viewing device to access the collection of electronic books, monitoring the user's in-book reading activity, and providing user analytics based on the monitored in-book reading activity. In embodiments, allowing a user's content viewing device to access the collection of electronic books may include providing an application for executing on the content viewing device that includes a user interface through which a user can view virtual covers of the electronic books. In embodiments, selecting a virtual cover in the user interface may cause a selection of a corresponding electronic book. In embodiments, allowing a user's content viewing device to access the collection of electronic books may include presenting virtual covers of the electronic books that facilitate single-click reading of a selected book.

In accordance with various illustrative but non-limiting embodiments, the systems and methods disclosed herein may include an electronic content distribution platform including an electronic content collection wherein the collection may include electronic content aggregated from a plurality of electronic content owners, a content distribution engine, an in-book activity monitor, a recommendation engine, a lifetime value calculating engine, a notification engine; and an analytics engine which derives analytics data from the in-book activity monitor, recommendation engine, lifetime value calculating engine, and notification engine.

In accordance with various illustrative but non-limiting embodiments, the systems and methods disclosed herein may include method including dividing an electronic book into a plurality of sequential sections, producing a graphical representation of each of the plurality of sequential sections, and configuring a first section vertically above a graphical representation of a second sequential section that immediately follows the first section in the sequence so that the configured first section and a portion of the graphical representation of the second section are displayable on a user's content viewing device to facilitate the user viewing the second section in response to vertically scrolling the configured first section. In embodiments, the graphical representation of the second sequential section may include a screenshot.

In accordance with various illustrative but non-limiting embodiments, the systems and methods disclosed herein may include method including providing a collection of electronic books, allowing a user's content viewing device to access the collection of electronic books, dividing an electronic book into a plurality of sequential sections wherein the plurality of sequential sections may include viewing content and a non-detailed content format representation of the viewing content, and configuring the viewing content of a first section on a user's content viewing device vertically above a non-detailed content format representation of the viewing content of a second section that immediately follows the first section in the sequence so that the configured viewing content of the first section and a portion of the non-detailed content format representation of the second section are displayable on a user's content viewing device to facilitate the user viewing the second section in response to vertically scrolling the configured viewing content of the first section. In embodiments, the graphical representation of the second sequential section may include a screenshot. In embodiments, the viewing content and non-detailed content format representation of the viewing content may be created by an electronic media data renderer, which may be an EPUB renderer. In embodiments, the EPUB renderer may use CSS3 columns. In embodiments, the configured viewing content may be configured by a layout engine, which may be WebKit. In embodiments, allowing a user's content viewing device to access the collection of electronic books may include providing an application for executing on the content viewing device that includes a user interface through which a user can view virtual covers of the electronic books. In embodiments, selecting a virtual cover in the user interface may cause a selection of a corresponding electronic book. In embodiments, allowing a user's content viewing device to access the collection of electronic books may include presenting virtual covers of the electronic books that facilitate single-click reading of a selected book.

In accordance with various illustrative but non-limiting embodiments, the systems and methods disclosed herein may include a method including providing a collection of electronic books, allowing a user's content viewing device to access the collection of electronic books, allowing a user to select an electronic book to be displayed on the content viewing device, dividing a user-selected book into a plurality of sequential sections, producing graphical representations of the plurality of sequential sections, displaying a first sequential section vertically above a graphical representation of a second sequential section on a display of user's content viewing device, and in response to a user vertically scrolling the display, displaying a second sequential section that corresponds to the graphical representation of the second sequential section and a graphical representation of a third section. In embodiments, a graphical representation of a sequential section may include a screenshot. In embodiments, allowing a user's content viewing device to access the collection of electronic books may include providing an application for executing on the content viewing device that includes a user interface through which a user can view virtual covers of the electronic books. In embodiments, selecting a virtual cover in the user interface may cause a selection of a corresponding electronic book. In embodiments, allowing a user's content viewing device to access the collection of electronic books may include presenting virtual covers of the electronic books that facilitate single-click reading of a selected book.

In accordance with various illustrative but non-limiting embodiments, the systems and methods disclosed herein may include a method including providing a collection of electronic books, allowing a user's content viewing device to access the collection of electronic books;

dividing a user-selected book into a plurality of sequential sections wherein the plurality of sequential sections include viewing content and a non-detailed content format representation of the viewing content, displaying a the viewing content of a first section on a user's content viewing device, displaying a non-detailed content format representation of the viewing content of a second section vertically below the viewing content of a first section, allowing the user to vertically scroll through the viewing content of the first section and replacing the viewing content of the first section with a non-detailed content format representation of the viewing content of the first section when the user has vertically scrolled a predetermined vertical scroll distance, replacing the non-detailed content format representation of the viewing content of the second section with a viewing content of a second section on a user's content viewing device when the user has vertically scrolled a predetermined vertical scroll distance, and displaying a non-detailed content format representation of the viewing content of a third section vertically below the viewing content of the second section. the graphical representation of the divided sections may include a screenshot. In embodiments, the viewing content and non-detailed content format representation of the viewing content may be created by an electronic media data renderer. In embodiments, the electronic media data renderer may be an EPUB renderer. In embodiments, the EPUB renderer may use CSS3 columns. In embodiments, the configured viewing content may be configured by a layout engine. In embodiments, the layout engine may be WebKit. In embodiments, allowing a user's content viewing device to access the collection of electronic books may include providing an application for executing on the content viewing device that includes a user interface through which a user can view virtual covers of the electronic books. In embodiments, selecting a virtual cover in the user interface may cause a selection of a corresponding electronic book. In embodiments, allowing a user's content viewing device to access the collection of electronic books may include presenting virtual covers of the electronic books that facilitate single-click reading of a selected book.

In accordance with various illustrative but non-limiting embodiments, the systems and methods disclosed herein may include a method including providing a collection of electronic books with a subscription-based reading application executing on a user's content viewing device, dividing the electronic books into a set of sequential book content sections in the collection, presenting a first sequential section for each of the plurality of electronic books to the user's content viewing device, allowing the user to select an electronic book based on the presented first sequential sections, in response to the user's selection of the presented first sequential section, accessing a second sequential section associated with the first sequential section from the collection, and presenting the second sequential section to the user's content viewing device. In embodiments, the method may include passively caching the remaining sections of the electronic book content to provide seamless transitions from each sequential section. In embodiments, the first sequential section may be presented instantly upon a user's content viewing device accessing the collection.

In accordance with various illustrative but non-limiting embodiments, the systems and methods disclosed herein may include a method include accessing virtual book covers for a plurality of electronic books that are accessible in a collection of electronic books with a subscription-based reading application executing on a user's content viewing device, presenting the virtual book covers to the user on the user's content viewing device in an interface that facilitates user access to contents of books in response to a one-click selection of a virtual book cover, wherein the contents of the books are organized as a set of sequential book content sections in the collection, in response to a user one-click selection of one of the presented virtual book covers, accessing a first section of book content associated with the selected virtual book cover from the collection and presenting content of a first page of the first section on the users content viewing device, while the user is viewing the content of a first page of the first section on the content viewing device, passively caching the remaining content of the first section of the electronic book, displaying the remaining content of the first section, and passively caching the remaining sequential sections while the user is viewing previously downloaded content.

In accordance with various illustrative but non-limiting embodiments, the systems and methods disclosed herein may include a method including providing a collection including electronic books, allowing a user's content viewing device to access the collection of electronic books, dividing a user-selected book into a plurality of sequential sections, transmitting a first section to a user's content viewing device, displaying the first section on a user's content viewing device, and transmitting the remaining sections in sequential order. In embodiments, allowing a user's content viewing device to access the collection of electronic books may include providing an application for executing on the content viewing device that includes a user interface through which a user can view virtual covers of the electronic books. In embodiments, selecting a virtual cover in the user interface may cause a selection of a corresponding electronic book. In embodiments, allowing a user's content viewing device to access the collection of electronic books may include presenting virtual covers of the electronic books that facilitate single-click reading of a selected book.

In accordance with various illustrative but non-limiting embodiments, the systems and methods disclosed herein may include an electronic content distribution platform including a collection including electronic content aggregated from a plurality of electronic content owners, a content distribution engine, a content dividing engine wherein the content dividing engine divides a user selected book into a plurality of sequential sections, and a passive caching engine.

In accordance with various illustrative but non-limiting embodiments, the systems and methods disclosed herein may include a method including providing a collection of electronic books allowing a user's content viewing device to access the collection of electronic books, providing a user selected book to the user's content viewing device including, dividing a user-selected book into a plurality of sequential sections, transmitting a first section to a user's content viewing device, displaying the first section on a user's content viewing device, transmitting the remaining sections in sequential order to a user's content viewing device, and displaying the remaining sections in sequential order on a user's content viewing device. In embodiments, allowing a user's content viewing device to access the collection of electronic books may include providing an application for executing on the content viewing device that includes a user interface through which a user can view virtual covers of the electronic books. In embodiments, selecting a virtual cover in the user interface may cause a selection of a corresponding electronic book. In embodiments, allowing a user's content viewing device to access the collection of electronic books may include presenting virtual covers of the electronic books that facilitate single-click reading of a selected book.

In accordance with various illustrative but non-limiting embodiments, the systems and methods disclosed herein may include a method including, providing a collection of electronic books, allowing a user's content viewing device to access the collection of electronic books, monitoring the user's in book reading activity of a book selected from the collection of electronic books, including when a user stops reading, and alerting the user when an inactivity time duration is reached. In embodiments, the user's in book reading activity may include reading progress. In embodiments, a user's reading progress may be determined using user view-page boundary words. In embodiments, determining user view-page boundary words may include taking a page size attribute of a user's content viewing device, determining an amount of viewable content for the page size, taking a first word of a section of an electronic book, calculating a page last word for a plurality of sequential pages of the electronic book based on the determined amount of viewable content and content in the section that follows the first word, and based on page last word information gathered when a page is viewed during a reading session, determining an extent of user reading of the electronic book during and across reading sessions.

In accordance with various illustrative but non-limiting embodiments, the systems and methods disclosed herein may include a method including providing a collection of electronic books, wherein the collection may include electronic books from a plurality of electronic content owners, and wherein a pricing model for each book is determined by the content owner as one of a wholesale-based pricing model and a retail-based pricing model, allowing a user's content viewing device to access the collection of electronic books, collecting subscription fees for allowing a user's content viewing device to access the collection of electronic books, and determining a content owner's share of collected subscription fees with a content owner fee calculator that determines a book-specific share for each book based on the pricing model for the specific book and aggregates the book-specific share for the content owner's electronic books that are available in the collection of electronic books. In embodiments, a content owner's share of collected subscription fees for a wholesale based pricing model may be determined by a sale trigger determination function. In embodiments, a content owner's share of collected subscription fees for a retail-based pricing model may be determined by a method including determining the amount of content provided by the content owner, determining the total amount of content provided by all content owners, and weighting the content owner's share of collected subscription fees against the total amount of content provided by all content owners. In embodiments, a content owner fee calculator may include determining subscriber device types or determining subscriber screen sizes.

In accordance with various illustrative but non-limiting embodiments, the systems and methods disclosed herein may include a method including providing a collection of electronic books, wherein the collection may include electronic books from a plurality of electronic content owners, and wherein a pricing model for each book is determined by the content owner as at least one of a wholesale-based pricing model, a retail-based pricing model, a duration-based pricing model, a completion-based pricing model, a popularity-based pricing model, and a cost-based pricing model, allowing a user's content viewing device to access the collection of electronic books, collecting subscription fees for allowing a user's content viewing device to access the collection of electronic books, and determining a content owner's share of collected subscription fees with a content owner fee calculator that determines a book-specific share for each book based on the pricing model for the specific book and aggregates the book-specific share for the content owner's electronic books that are available in the collection of electronic books. In embodiments, a content owner's share of collected subscription fees for a wholesale based pricing model may be determined by a sale trigger determination function. In embodiments, a content owner's share of collected subscription fees for a retail-based pricing model may be determined by a method including determining the amount of content provided by the content owner, determining the total amount of content provided by all content owners, and weighting the content owner's share of collected subscription fees against the total amount of content provided by all content owners. In embodiments, a content owner fee calculator may include determining subscriber device types or determining subscriber screen sizes.

In accordance with various illustrative but non-limiting embodiments, the systems and methods disclosed herein may include a method including providing a collection of electronic books, allowing a user's content viewing device to access the collection of electronic books, monitoring the user's in book reading activity, and generating a list of recommended books based on the user's in book reading activity. In embodiments, in-book user activity may include a user's reading progress. In embodiments, a user's reading progress may be determined using user view-page boundary words. In embodiments, determining user view-page boundary words may include taking a page size attribute of a user's content viewing device, determining an amount of viewable content for the page size, taking a first word of a section of an electronic book, calculating a page last word for a plurality of sequential pages of the electronic book based on the determined amount of viewable content and content in the section that follows the first word, and based on page last word information gathered when a page is viewed during a reading session, determining an extent of user reading of the electronic book during and across reading sessions.

In accordance with various illustrative but non-limiting embodiments, the systems and methods disclosed herein may include a method including, providing a collection of electronic books, allowing a user's content viewing device to access the collection of electronic books, monitoring the user's in book reading activity, analyzing the user's in-book reading activity to determine an extent to which the user has read the electronic book, comparing the extent to which the user has read the electronic book to an activity threshold, and based on satisfying the threshold in the comparison, providing a recommendation to the reader of the electronic book. In embodiments, in-book user activity may include a user's reading progress. In embodiments, a user's reading progress may be determined using user view-page boundary words. In embodiments, determining user view-page boundary words may include taking a page size attribute of a user's content viewing device, determining an amount of viewable content for the page size, taking a first word of a section of an electronic book, calculating a page last word for a plurality of sequential pages of the electronic book based on the determined amount of viewable content and content in the section that follows the first word, and based on page last word information gathered when a page is viewed during a reading session, determining an extent of user reading of the electronic book during and across reading sessions.

In accordance with various illustrative but non-limiting embodiments, the systems and methods disclosed herein may include a method including providing a collection of electronic books, providing an application for a content viewing device through which a user's content viewing device can access the collection of electronic books, wherein the access is based on a subscription that the user holds with a provider of the collection of electronic books, and wherein the application has access to the user content viewing device location information, and allowing the user's content viewing device to access the restricted collection of electronic books when the user content viewing device is determined to be in a predetermined location.

In accordance with various illustrative but non-limiting embodiments, the systems and methods disclosed herein may include a method including providing a collection of electronic books, providing an application for a content viewing device through which a user's content viewing device can access the collection of electronic books, wherein the access is based on a subscription that the user holds with a provider of the collection of electronic books, and wherein the application has access to viewing device location information, and managing access rights to the content within the viewing based on the location of the viewing device.

In accordance with various illustrative but non-limiting embodiments, the systems and methods disclosed herein may include a method including providing a collection of electronic books that can be accessed by subscribers to an electronic book serving subscription service, providing an application for executing on a subscriber's content viewing device that facilitates user selection, reading, and annotating of one more of the electronic books, and in response to receiving subscriber authorization for sharing a specific book, allowing a second subscriber who has selected the specific book to view the first subscriber's annotations while reading the specific book on the second user's content viewing device.

In accordance with various illustrative but non-limiting embodiments, the systems and methods disclosed herein may include a method including providing a collection of electronic books that can be accessed by subscribers to a subscription-based electronic book serving service of the collection provider, wherein the collection may include electronic content from a plurality of electronic content owners, allowing subscribers' content viewing devices to access the collection of electronic books, monitoring subscribers' activity when accessing the collection of electronic books, including a type of content viewing device being used by the subscribers, collecting subscription fees from the subscribers for allowing access to the collection of electronic books, aggregating the subscription fees via a content owner payment facility; and determining a content owner's share of the aggregated subscription fees based on the subscribers' monitored activity and based at least in part on the type of content viewing devices being used by the subscribers via a revenue sharing calculator. In embodiments, the method may include distributing a content owner's share of subscription fees based on the determination. In embodiments, the monitored activity may include a subscriber's reading progress. In embodiments, a subscriber's reading progress may be determined using user view-page boundary words. In embodiments, determining user view-page boundary words may include taking a page size attribute of a subscriber's content viewing device, determining an amount of viewable content for the page size, taking a first word of a section of an electronic book, calculating a page last word for a plurality of sequential pages of the electronic book based on the determined amount of viewable content and content in the section that follows the first word, and based on page last word information gathered when a page is viewed during a reading session, determining an extent of subscriber reading of the electronic book during and across reading sessions.

In accordance with various illustrative but non-limiting embodiments, the systems and methods disclosed herein may include a method including providing a collection of electronic books that can be accessed by subscribers to an electronic book subscription service of the collection provider, allowing subscribers' content viewing devices to access the collection of electronic books, monitoring activity of the subscribers accessing the collection, collecting data with respect to at least one activity of the subscribers with respect to at least one other resource apart from the collection, and processing the monitored activity on access to the collection and the collected data with respect to the other resource to determine at least one analytic result relating to the electronic book subscription service. In embodiments, the monitored activity may include a subscriber's reading progress. In embodiments, a subscriber's reading progress may be determined using user view-page boundary words. In embodiments, determining user view-page boundary words may include taking a page size attribute of a subscriber's content viewing device, determining an amount of viewable content for the page size, taking a first word of a section of an electronic book, calculating a page last word for a plurality of sequential pages of the electronic book based on the determined amount of viewable content and content in the section that follows the first word, and based on page last word information gathered when a page is viewed during a reading session, determining an extent of subscriber reading of the electronic book during and across reading sessions.

In accordance with various illustrative but non-limiting embodiments, the systems and methods disclosed herein may include a method including providing a collection of electronic books, providing an application for a content viewing device through which a user's content viewing device can access the collection of electronic books, wherein the access is based on a subscription that the user holds with a provider of the collection of electronic books, and wherein the application has access to the user content viewing device location information, and allowing the user's content viewing device to have unlimited access to a first portion of content in at least one electronic book and to have restricted access to a second portion of content in the at least one electronic book based on the viewing device location information.

### BRIEF DESCRIPTION OF THE DRAWINGS

The systems and methods described herein may be understood by reference to the following figures:

FIG. 1 depicts an embodiment of a method for generating recommendations based on in-book reading activity in a subscription based electronic book business model.

FIG. 2 depicts an embodiment of a lifetime value model for a book to determine publisher value in a subscription based electronic book business model.

FIG. 3 depicts an embodiment of a method for determining dynamic sample reading percentage or threshold as well as a pricing module for clearing wholesale and retail pricing of electronic books.

FIG. 4 depicts an embodiment of a method for distributing electronic books with access terms based on location and for providing conditional access to electronic content based on location relative to a partner facility or network.

FIG. 5 depicts an embodiment of a web kit based electronic book reader facilitating one click reading on a mobile device.

FIG. 6 provides a block diagram of an embodiment of a method for controlling user reading speed or jumping based on tracking the extent of content previously viewed.

FIG. 7 depicts an embodiment of a publisher analytics portal.

FIG. 8 depicts an embodiment of a platform for rendering vertically paginated content.

FIG. 9 depicts steps of an embodiment of a method for determining the extent of reading an electronic book based on device-specific user view page boundary words.

### DESCRIPTION OF THE PREFERRED EMBODIMENTS

The present invention will now be described in detail by describing various illustrative, non-limiting embodiments thereof with reference to the accompanying drawings and exhibit. The invention may, however, be embodied in many different forms and should not be construed as being limited to the illustrative embodiments set forth herein. Rather, the embodiments are provided so that this disclosure will be thorough and will fully convey the concept of the invention to those skilled in the art. The claims should be consulted to ascertain the true scope of the invention.

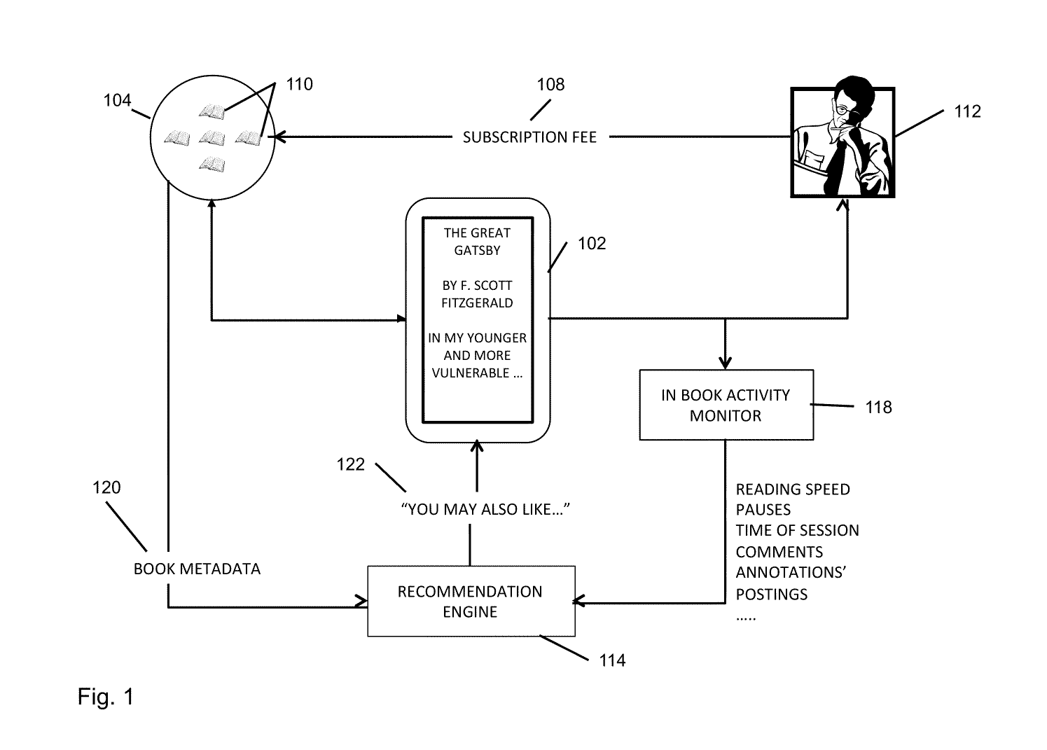

Referring to FIG. 1 and in embodiments, the systems and methods disclosed herein may comprise providing recommendations based on in-book reading activity in a subscription-based e-book business model. The systems and methods disclosed herein may comprise a reading platform or accessing a database 104 of electronic books. The reading platform may allow users to access the database 104 of electronic books after paying a subscription fee 108 (e.g. one lifetime fee, periodically, such as monthly, semiannually, annually, etc.). Users 112 may access the database 104 via a mobile device 102, such as a smart phone, tablet, and the like. The mobile device 102 may serve as both a host to a reading platform from which the user accesses and reads electronic books 110, as well as a client device from which the user 112 communicates with the database 104. The mobile device 102 hosting a reading platform may be referred to herein as a content viewing device. In embodiments, the systems and methods disclosed herein may comprise a recommendation engine 114. In embodiments, the systems and methods disclosed herein may comprise an in book activity monitor 118. The in book activity monitor may aggregate data about a user's 112 reading habits and provide the information to the recommendation engine 114. The recommendation engine may analyze data collected by the in book activity monitor 118, along with book metadata 120 collected from the database 104 to generate recommendations 122 to users 112 via the mobile device 102. Various algorithms and statistical models may be employed by the recommendation engine to generate its results which are known to the art, such as, but not limited to, similarity-based models, collaborataive filtering models, neural networks, robust regressions, random forests, CART, semiparametric regressions, and naïve Bayesian classifiers, among others.

The reading platform in cooperation with a subscription-based reading host may allow users to access information about the devices and books of other uses using the same or similar reading platforms. In a non-limiting example of accessing other users' book related information, the reading platform may allow users to “borrow” other user's books, in order to see their annotations or comments, among others. Users may share annotations globally, such as via a social network, or to selected individuals, such as to a private book group, among other non-limiting examples.

In embodiments, the users may be allowed to modify content. Such functionality may be deployed when a user wishes to highlight, comment, or annotate specific passages within a book. As described above, users may make such modifications above to create user-specific instances of an electronic book. Modifications to the content may not alter the original base content of the electronic book, but may be stored within a user's specific device or stored in such a manner that it is associated with a user's particular account. This functionality may be deployed so as to not affect the content of all reading platform users, but only for an individual user to view and share with friends. Modifications may be used by the platform to encourage discussion about the book or enhance a reader's experience. In a non-limiting example, modifications made by celebrities, or by the author, may be made available to all platform users or as a premium feature, so that individuals may compare modifications to gain insight into the book or about the modifier. In a non-limiting example, an author may provide special content with notes and highlights describing why he or she made certain choices when writing the book. In embodiments, users may share their notes and highlights with friends or other users to encourage discussion about the book. Such functionality may also be deployed as a marketing tool to encourage global discussion about a book or to generate interest, among other uses. In embodiments, the user modifications may be categorized as annotations, highlight, suggestions, questions, error/typo detection, content error detection (e.g. mistakes in continuity), among others. Users may be able to choose the modifications from a suggested list of modification categories or create their own.

In particular, the systems and methods disclosed herein may comprise a recommendation engine. The recommendation engine may analyze books for certain substantive traits, such as, but not limited to, length of chapters, subject matter, writing style, author, etc. The recommendation engine may also account for a user's preferences. In a non-limiting example of recommendations based on user preferences, the recommendation engine may display more murder-mystery type books than autobiographies if, based on the reader's explicit or implicit indication of an interest in fiction books rather than nonfiction.

The recommendation engine may take into account both explicit and implicit user actions in order to analyze a reader's habits, and in turn, a reader's preferences. The recommendation engine may analyze physical habits such as, but not limited to, where a reader pauses, where a reader stops reading, where a reader reads faster or slower, and the time of a reader's session, among others. Data about such physical habits may be provided by the in book activity monitor. Other actions that the recommendation engine may use to generate recommendations may be explicit actions that are not directly related to reading an electronic book, such as, but not limited to, adding a book to a list, sharing a book, viewing a book synopsis, reading a review of a book, how a user's friends or followers on social services (TWITTER, FACEBOOK, etc.) react to certain books, friends activities using the reading platform, among others.

The recommendation engine may also analyze implicit actions from a user both while reading a book and when using the electronic book platform but not reading, such as, but not limited to, browsing for books and not selecting books already viewed, rereading sections, stopping a book after a certain number of chapters, etc. The recommendation engine may also analyze other variables not related to using the platform at all, such as, but not limited to, demographics, age, gender, location, profession, socioeconomic status, etc.

The recommendation engine may use these analyses to generate certain user metrics as well as certain book metrics. In turn, the recommendation engine may use these metrics to compare to other users with similar metrics. The recommendation engine may then use these metrics to generate recommendations and display those recommendations to a user via the reading platform. In a non-limiting example, the recommendation engine may identify that Book A has similar book metrics to Book B, and recommend Book B to a user. Likewise, the recommendation engine may identify that User X liked Book A, and thus recommends it to User Y, who has similar user metrics as User X. The recommendation engine may additionally recommend books that are popular amongst the general reading population, but might not necessarily be accounted for by a user's metrics. For instance, in a non-limiting example, a user may have a book recommended that is generating news, or is popular/trending on social networking sites.

The recommendation engine and methods and systems for analyzing data and preparing recommendations may be performed on the mobile device, on a networked server, on a plurality of networked servers, and/or on combinations thereof. Data related to the inputs described above may be collected over time, and recommendations may be provided to users of the subscription-based electronic book service from time to time, such as without limitation, when it is determined that the user is close to finishing reading a book, when a publisher announces a new book to be released in the near future, when a user has paused reading of a book for a predetermined amount of time, when a publisher is interested in gathering user input regarding books to publish, on a schedule, periodically, and the like.

The reading platform may comprise a user interface. The user interface may display a number of items that a user may interact with, including, but not limited to, books that a user can browse, ratings of books, books that user has read in the past, books that a user is currently reading, discussions of individuals reading the same book or friends of the user, book and user metrics of the user and others, etc. The user interface may provide visual feedback around progression and accomplishments both while reading the book itself or while using the reading platform. In a non-limiting example, a user may receive a badge or an award message when the user has read five books, or when a book that the user has recommended is featured by the reading platform. The user interface may display the recommendations generated by the recommendation engine to the user. The user interface may display digital images of book covers that are designed to look like actual book covers by layering shadows on the book image to simulate a naturally lighted space. The user interface may provide options for typeface, font size, colors, and other aesthetic options aggregated into themes so that user may intelligently select a preferred set of aesthetic options.

The methods and systems disclosed herein may comprise a method for a subscription model for electronic books. The subscription model may comprise granting access to the database of electronic books with a periodic subscription fee. The subscription model may comprise allowing users to download alternative media to supplement their subscription, such as, but not limited to, related television shows, movies, hard cover books, full digital downloads. In a non-limiting example, when a user has decided to end the subscription, the user may be directed to a link to download a book the user was reading but had not finished. The subscription model may grant users access to a version of the electronic book that is missing certain features. The user may have to pay an additional fee if a user wishes to access these premium features, such as, but not limited to, access to original drafts, alternative endings, customized artwork, unlimited database access, among others. Such functionality may also be implemented by content providers to give previews to users or other marketing uses. The subscription model may comprise granting users the ability to group together electronic books into lists within the subscription service. The subscription model may comprise providing tiers of subscription access. In a non-limiting embodiment, regular subscribers may only have access to 100 books a year, whereas premium subscribers may have unlimited access. In embodiments, premium subscribers may have access to special features whereas the regular subscribers may have to pay an additional fee to access special features. Such features may include, but are not limited to, special author notes, additional drawings, additional chapters, alternate endings, original manuscripts, and previews of upcoming books by the same author or content provider, etc.

In embodiments, the subscription model may comprise providing a complimentary service. In a non-limiting example, the complimentary service may be deployed in the form of a complimentary application. The complimentary service may provide time-limited access to the database. In a non-limiting example of providing time limited access to a database of electronic books, the application may only offer books for a certain period of time in which a user must finish a book before the book is removed from the user's device. Likewise, a user who chooses not to select the book offered that day may have to wait until the next day in order to access another complimentary book. The complimentary service may provide content limited access to the database. In a non-limiting example of providing content limited access, the user may have to finish reading a complimentary book before the user may access a new book. Such embodiments may provide useful for marketing purposes or to assess user interest in a particular type of book, among other uses.

The methods and systems disclosed herein may comprise a notification engine. The notification engine may remind a user to resume reading a book the user has abandoned, remind users to discuss books with friends that are reading the same book, among others. The notification engine may also remind users of subscription service policies, such as, but not limited to, if users who use the complimentary service abandon a book, the user may not get a new book until the next month. In a non-limiting example, the notification engine may look into a user's particular reading history and generate a reminder based on an individual's responses to reminders in the past. The notification engine may then try and adjust future notifications based on that behavior. For instance, if a user constantly chooses to ignore notifications about an unfinished book, the notification engine may notify the user after longer periods of time. If a user continues to ignore notifications, it may indicate that the user has abandoned the book. Notifications may be triggered based on a user's actual progress or location within a piece of content. Users themselves may trigger notifications. In a non-limiting example, a user may select an option in the reading platform via the user interface to remind them to return to a book after X days of inactivity. When a user is inactive for a period of time, the user may be sent a recommendation based on inactivity. When a user is inactive, the reading platform may also remind the user to return to the book or content or suggest an alternative piece of content. Additionally, the notification may ask a user to rate a book or content item after a certain period of inactivity. Such recommendations may be used as an input to recommend alternative content to other users or as an input for the inactive user's future book recommendations. In embodiments, content owners may also be notified when a user is inactive for a certain period of time. Content owners may also be notified of inactivity for multiple users. Such information may be used to determine the lifetime value of a book or simply be delivered as data for a content owner, among others. Inactivity amongst multiple users may also be delivered as data for a content owner to analyze or help determine the lifetime value of a book, among other uses. In embodiments, such notifications to content owners may be delivered via the publisher analytics portal and its associated dashboard, as described in other sections of this disclosure. Notifications may be triggered when others are in the same location or if others are consuming the same content at the same time. Such notifications may be accompanied by a link to a discussion platform, such as, but not limited to, a link to Twitter. The notification engine may also create notifications to generate value within the subscription service. In a non-limiting example, the notification engine may deliver a “Weekly Staff Picks” notification, where the service provider may give periodic recommendations for new content. The recommendations may be related to a thematic set, such as, but not limited to, a notification about service provider employees' favorite sports books in January, followed by a notification about employees' favorite science fiction books in February. In another non-limiting example, the notification engine may deliver a “New Today” book recommendation, where recently published or recently acquired content may be recommended. Other users may also use the notification engine for direct recommendations to other users. These recommendations may be customized. In embodiments, user may use the recommendation and notification engine in conjunction to send gifts (such as, but not limited to, buying access to a premium book) to other users. In a non-limiting example, the notification engine may alert the user that friend's birthday is approaching and may then recommend certain books to give as a gift to the friend.

Providing a subscription model for reading multiple books presents a challenge, as the library of inventory for a publisher may be acquired based on a per-book pricing model. So, the ability of a publisher to make a profit depends heavily in a subscription model on the behavior of subscribers. The systems and methods disclosed herein may comprise a lifetime value model for a book to enable determination of publisher value in a subscription based electronic book business model. The lifetime value model may be based on a number of inputs, including the amount that users typically spend reading books, the amount of time users actually spend reading a particular book, and the like. Time amounts may be aggregated across users and over time. The lifetime value model may also be based on the rate of attrition, or churn, within the subscription service. The lifetime value model may be used to predict after what period of time a user will churn, or leave the subscription service. The lifetime value model may be used to learn the impact on the churn rates for various users that specific or combinations of book as well as the actions associated with those books will have. The amount that users read an individual book may impact the amount a subscription service provider may pay a content owner for individual books. The lifetime value model may prove useful to content providers to determine the true value of a book, so that they may accurately build on their business.

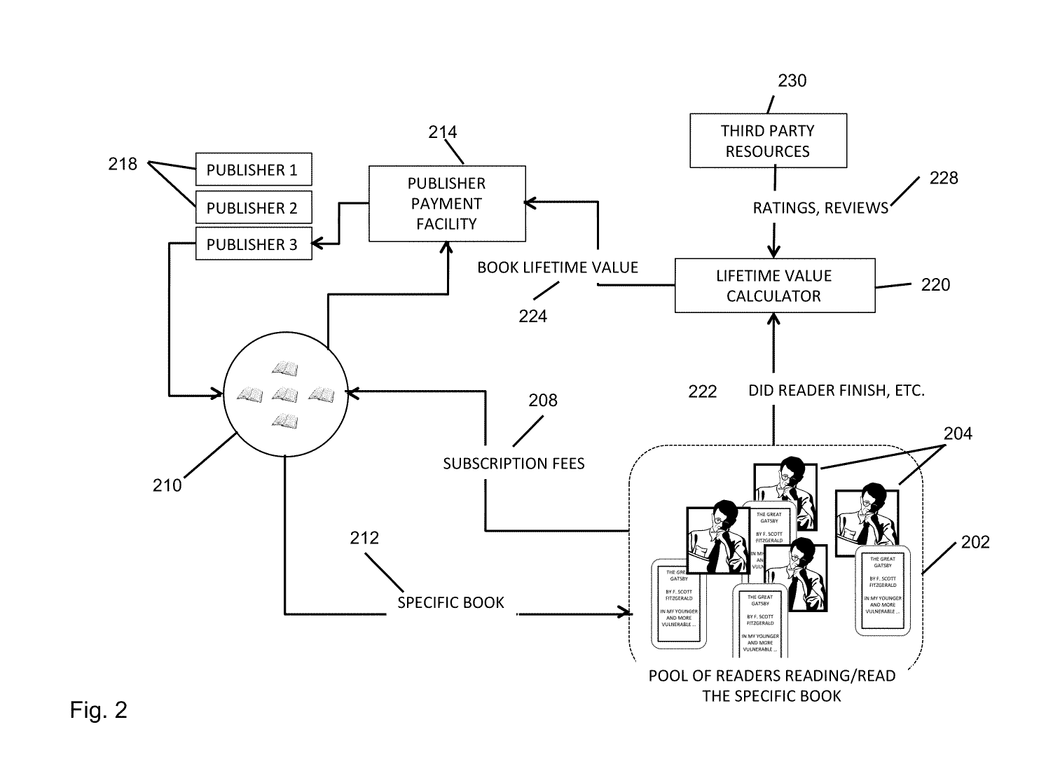

In embodiments and referring to FIG. 2, the lifetime value model may comprise aggregating a pool 202 of users 204 reading a specific book 212, or users 204 who have already read the book. The users 204 may be required to pay a subscription service provider subscription fees 208 in order to access a subscription service provider's database 210 of electronic books as well as other content. The subscription service provider's database 210 may be populated by the content from a plurality of content owners or publishers 218. The lifetime value model may comprise a lifetime value calculator 220. The lifetime value calculator 220 may determine a specific book's 212 lifetime value 224 based on data or metrics derived from a user's book-related behavior 222, such as, but not limited to, whether a reader finished the book. The lifetime value calculator 220 may also determine a specific book's 212 lifetime value 224 based on data or metrics derived from external book-related behavior 228, such as, but not limited to, ratings or reviews on social networks or syndicated publications 230. The lifetime value model may comprise a publisher payment facility 214. The publisher payment facility may distribute subscription fees 208 to content owners or publishers 218 based on a book's lifetime value 224, as determined by the lifetime value calculator 220.

The lifetime value model may comprise a lifetime value calculator. The calculator may use a statistical model to determine the business value of a particular book based on customer ratings and reviews, critics review, price (e.g. retail or wholesale, hardcopy, paperback, or electronic), whether the book was on the best seller list, among others, each of which may be used as an input to predict user behavior with respect to the book. Various algorithms and statistical models may be employed by the calculator to generate its calculations which are known to the art, such as, but not limited to, expected value models, models reflecting decay/abandonment rates, probabilistic models, models based on churn, models based on activity or inactivity, and models using artificial intelligence optimization techniques (such as neural networks), simulation-based models, such as random forest models, models using regression techniques, such as linear regressions, robust regressions, CART, semiparametric regressions, and the like, and Bayesian models, among others. The lifetime value calculator may aggregate and analyze data from social networking sites that reflect sentiment towards a specific book. In a non-limiting example, the calculator may look through TWITTER to see if there is a trending hashtag for Book A, while also looking through FACEBOOK for the number of “Likes” that Book A's dedicated page has received. The lifetime value calculator may aggregate and analyze data through critical sources, such as, but not limited to, the New York Times book reviews, Neilson bookscan, and the like to inform the calculation. The lifetime value calculator may analyze this aggregated data in conjunction with a user's reading behavior (similar to the metrics used by the recommendation engine) in order to calculate the lifetime value of a specific book, or book lifetime value.

Users may pay a subscription fee that is aggregated into a revenue pool of subscription fees. The pool of subscription fees may be paid to content owners (e.g. book publishers) based on the aggregate of the content owner's book lifetime values with respect to other content owners. The determination of how much a content owner is paid may be determined by a content owner payment facility, which takes into account book lifetime value of specific books a content owner has in the database. The lifetime value model may comprise allowing content owners to receive, where the payment given to a specific content owner is determined by the number of times the content owner's content is consumed, divided by the total number of content items consumed, weighted by a comparable wholesale price of the content. The fraction of revenue given may be determined by the value of the content provided by content owners, as determined by the book lifetime value calculator, divided by the total value of content items consumed, weighted by the wholesale price of the content.

In embodiments, the recommendation engine may use the lifetime value calculator, along with other metrics, in order to determine a recommendation that may be optimized for a given user. In embodiments, the recommendation engine may analyze book lifetime value in order to generate recommendations that maximize income for the subscription service provider. In embodiments, similarly, the lifetime value may be taken into account to generate a recommendation that may not necessarily maximize income for the subscription service provider, but may be at a desired level of both cost to the subscription service provider and the lifetime value of the book. Recommendations made to each individual user may vary depending on the user's reading metrics, among others, in relation to the book lifetime value. Likewise, the notification engine may inform the lifetime value model by providing data as to how a user responds to certain notifications. This behavior, taken with in-book reading behavior, critical reception, and the number of other sets of data accounted for by the recommendation engine, may all be used to determine a recommendation with respect to book lifetime value. The notification engine may trigger messages based on a user's progress or location within a piece of content. In a non-limiting example, a user might receive a notification message at the end of Book A directing the user to read the next book in the series, Book B. A user who chooses to directly read the Book B may lead to the lifetime value calculator determining that Book A has a higher book lifetime value.

In embodiments, the lifetime value model may be used not only to determine the amount that should be paid to a content owner or publisher, but other purposes as well. In embodiments, the lifetime value may be used to estimate the lifetime value of similar books. In a non-limiting example, books which are by the same author may be estimated at a similar lifetime value levels. Such estimates may provide useful to content owners who engage with the platform to actively market or assess the business value of taking on certain projects. In a non-limiting example, books which are in the same genre or talk about similar topics may have similar estimated lifetime values. Content owners or publishers may take the estimated lifetime value into account when making editorial or plot changes, among other uses. The lifetime value of a book may also be used to determine which books are more prominently displayed to a user's content viewing device, either via the platform interface, recommendation engine, or other method. Books with higher lifetime value may be listed in a “popular” section in order to maximize traffic to the book, thus optimizing content owner or publisher value. Similarly, books with lower lifetime value may be listed in a “featured” section in order to drive up lifetime value. Books with lower lifetime value may also be used in a more interactive way with platform users. In a non-limiting example, a content owner may hold a contest to see if users can make a low lifetime value book better, or generate a higher lifetime value with reader-submitted alterations. In embodiments, the lifetime value may be used as an input for other algorithms or models. In a non-limiting example, the lifetime value may be used as an input for a book-related ancillary cost model. Such a model may predict metrics such as reader churn rate, reader retention, and the like. The model may rely on lifetime value to predict reader retention by determining that readers that read higher lifetime value books are more likely to be retained. Reader churn may be determined by assessing the volume of lower lifetime value books read across the entire platform.

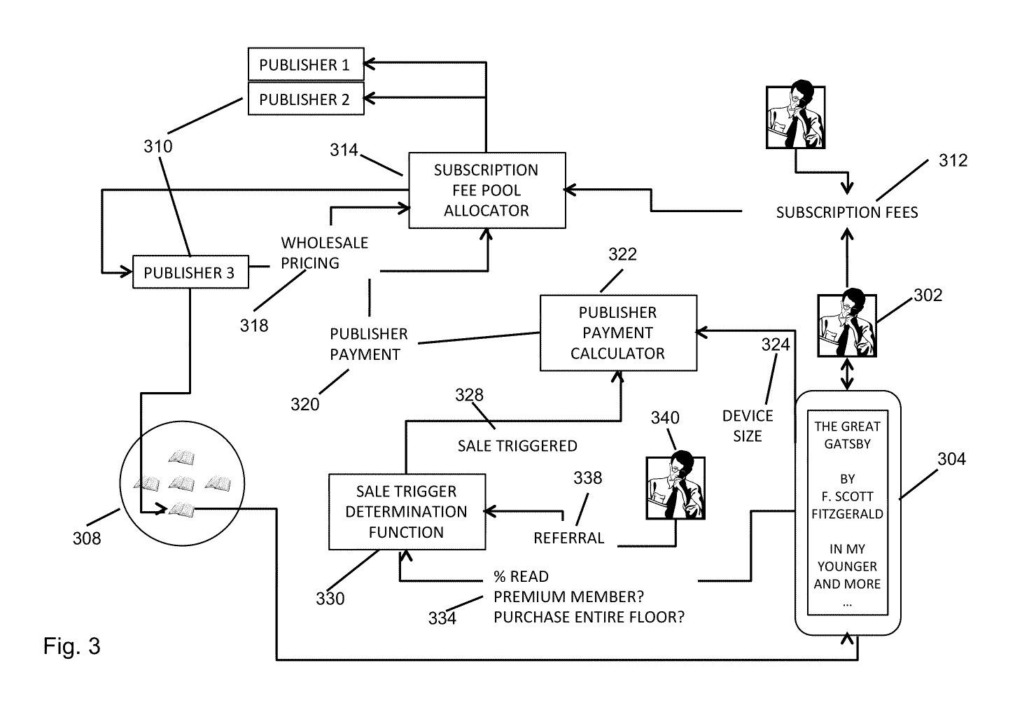

The systems and methods disclosed herein may comprise a dynamic sample reading percentage/threshold for publisher payment determination. Referring to FIG. 3 and in embodiments, users 302, via devices 304 hosting a reading platform, may access a database 308 of electronic content, such as, but not limited to, electronic books. Content owners and publishers 310 may contribute content to the database 308. Users may gain access to the database 308 by paying a subscription fee 312. Subscription fees 312 may be aggregated redistributed to content owners and publishers 310. Subscription fees may be sent to a subscription fee pool allocator 314 in order to determine how much payment should allocated to each content owner or publisher 310. Payment may be based on a percent of the subscription pool or it may be determined in other ways. A publisher payment may be determined on a retail pricing or wholesale pricing basis 318. The subscription fee pool allocator may also facilitate determining what portions of fees are related to a publisher's payment 320. A payment calculator 322 may determine a publisher's payment. The payment calculator may determine the publisher's payment 320 based on the device size 324 that the user may be using to view content, or whether a sale of content is triggered 328. In a non-limiting example, a user X may have read one page of Book A before abandoning it; thus, Book A's sale is not triggered, and Book A's publisher will not receive a payment for user X's reading. Whether a sale of content is triggered 328 may be determined by a sale trigger determination function 330. The sale trigger determination function 330 may base its determination off of a user's reading behavior or information 334, such as, but not limited to, the percentage of the content viewed by the user 302 or whether the user 302 is a premium subscriber, among others. The sale trigger determination function 330 may additionally base its determination of external factors 338, such as, but not limited to, whether the content was referred to the user 302 by another user 340.

In embodiments, the dynamic sample reading percentage may be used to determine when the subscription service provider may record a “sale” for a piece of content, therefore triggering a wholesale payment to a content owner, or sale trigger determination function. The sale trigger determination function may comprise querying the reading platform to indicate the first and last elements of each portion of the content. In a non-limiting example, the subscription service provider may query a reading platform to log the first and last elements of each page. These elements may then be recorded as HTML paths (similar to an XPATH expression) and is logged on a server. This information may produce a start and end tuple of all of the words each user has seen on the screen. By calculating the union of the tuples, the subscription service provider may determine the percentage of words that have appeared on the screen with respect to the total number of words that a book has.

The systems and methods disclosed herein may comprise a pricing module for clearing wholesale and retail pricing of electronic books where wholesale and retail pricing are not determined using the same unit basis. The pricing module may comprise a wholesale pricing model where a content provider is paid each time their content is consumed. Content may be “consumed” when a user reads beyond the sale trigger threshold. The sale trigger threshold may be determined when the first X % of content is consumed, rather than any X % of consumption. The subscription service provider may pay a fixed price for each book to the content owner.

The pricing module may comprise a retail pricing model distinct from the wholesale model. The retail pricing model may comprise a payment system where a portion of payment given to a content provider is based on the weight of the content value in relation to other content owners in a pool. The payment system may be based on the weight of the amount of content provided by a certain owner in relation to other content owners in a pool. The wholesale and retail pricing models may be implemented in conjunction with each other, or independently. The model may comprise making payments to content owners based on the portion of content that is consumed as well as adjusting payments based on device type, or screen size.

The systems and methods disclosed herein may comprise a business model for revenue sharing based on electronic book related activity and device characteristics. The model may comprise implementing different subscription tiers. In a non-limiting example, premium members may have access to samples of new books, or may have preferred access to samples of new books. Likewise, the sale trigger threshold may be different when premium members consume content, as opposed to standard subscribing members. Premium members may have access to restricted content, or more restricted content than standard subscribers. Members may promote, share, or review content in order to unlock restricted content or discounts.

Content or subscription restrictions may be implemented in various forms, such as, but not limited to, granting licensing or sale rights to different forms of media (e.g. complimentary TV episode for premium subscribers) or devices of a certain screen size (e.g. applications optimized only for devices of less than 6 inches), providing time-limited access to a piece of content in relation to the content's release date, or providing access to different slices of a subscription library. The model may comprise bundling a purchase of complementary pieces of content, such as, but not limited to, allowing users who buy a digital copy of a book to receive a discount for purchase of the print book. In a non-limiting example, a subscriber may have access to Book A on laptop, but may have to purchase an additional set of rights to access Book A via mobile phone.

In embodiments, access to e-book content, or full access to content that is otherwise limited, may be based on location of the reader, such as detected by GPS, triangulation, or database access techniques, among other methods readily known to the art. For example, a reader may be given full access to textbooks while residing at the user's home (the location being stored and associated with the user's identifying information in a data storage facility associated with the system described herein) or at the user's academic institution, but the content may be locked at other locations, such as to prevent a user from giving away a subscription-based text book to another user. Access to a full version outside designated locations could be allowed only after undertaking additional access verification steps, such as having a user provide additional authentication details. Such digital rights management methods are readily known to the art. In another example, access to business-relevant content could be constrained to a location of a business enterprise. Employee access to sensitive documents may be conditionally provided while the employee is still on company premises, connected to a secure company signal, or both.

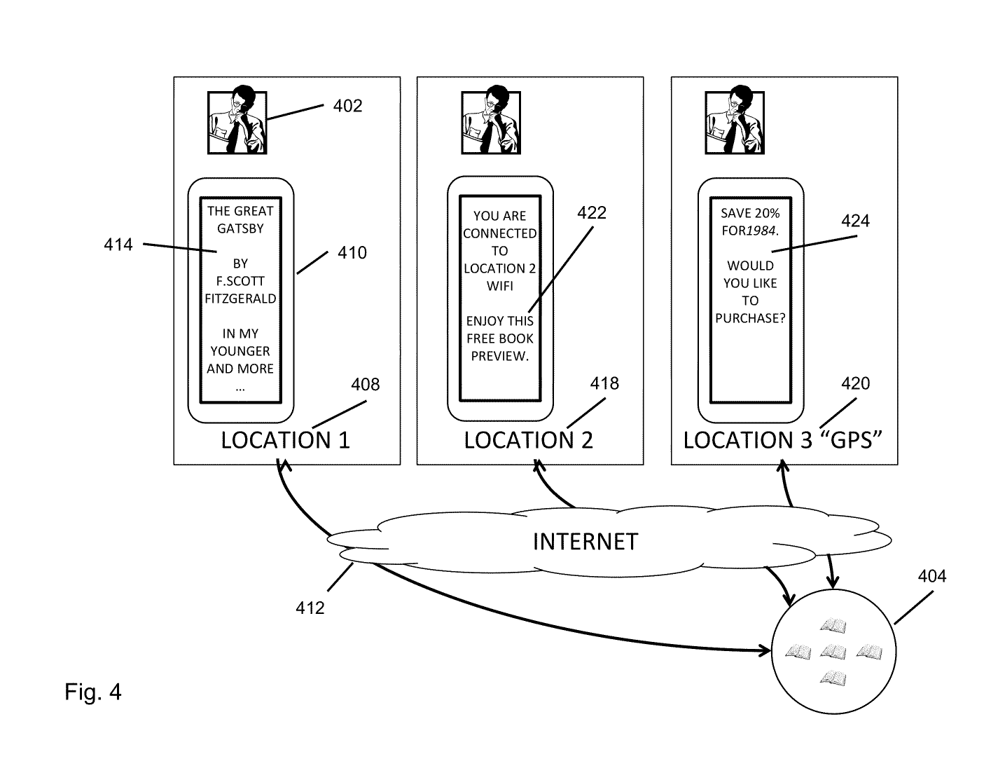

The systems and methods disclosed herein may comprise conditional access to an electronic book based on location relative to a partner facility or network. The systems and methods disclosed herein may comprise electronic book distribution with access terms based on location. In embodiments and referring to FIG. 4, content provided by a subscription service may be sealed, free, priced differently, or otherwise restricted to user access based on a user's 402 network connection information. In a non-limiting example, a user 402 may be able to access a sealed book from an electronic database 404 when a user is at a first location 408. The user's device 410 may communicate the user's location via the Internet 412, to the database 404, thus allowing the user 402 access to the sealed electronic book 414. In another non-limiting example, a user at a second location 418 may access the database 404 via the Internet 412 using the user's device 410. The user may connect to the Internet 412 via a local area connection, such as a local Wi-Fi. The database 404 may detect that that user 402 is using the second location's 418 local connection and may grant access to free content 422. In another non-limiting example, the database 404 may detect that a user 402 is in a third location 420 via GPS and then offers a discount on content 424 to the user 402.

In a non-limiting example of location based conditional access, users may be able to access a full book if they are in proximity to a partnered area or connected to a partner's network, such as, but not limited to, a coffee shop, airport, or mall, among others. Location information may be based on mobile device GPS location, wireless network access, and the like. Likewise, content may be exclusive to certain locations or networks. In another non-limiting example, Book A may be available only in Coffee Shops X, Y, and Z before its actual release date. Similarly, a preview of Book A may be made available if not the entire book. A user's location may also unlock promotional discounts to content. In a non-limiting example of location based discounting, premium services may be made available at a 20% discount when purchased at an airport, or when a user is connected to an inflight WiFi service.

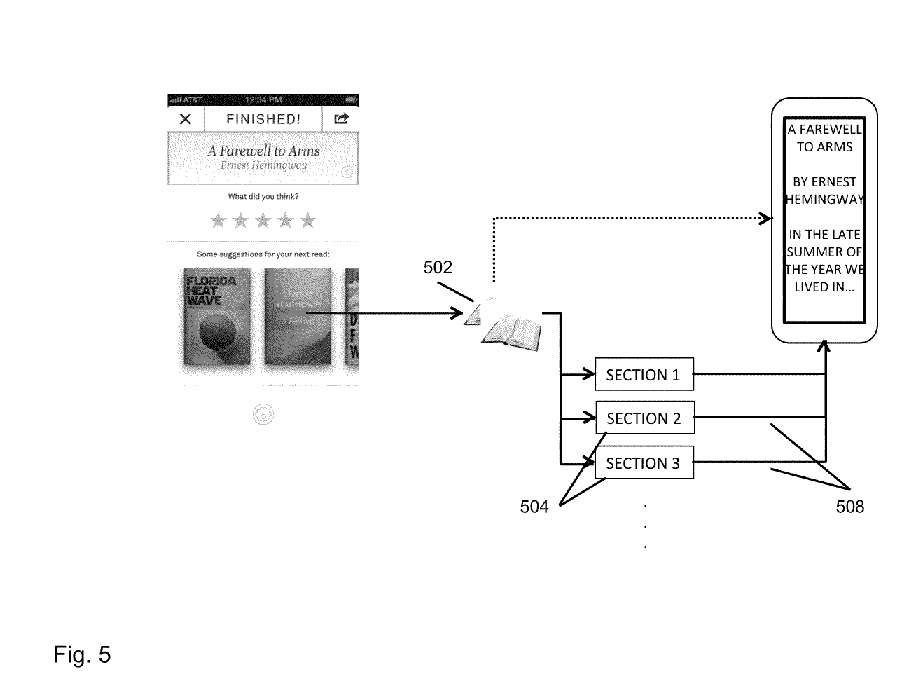

The systems and methods disclosed herein may comprise a web-kit based e-book reader facilitating one-click reading on a mobile device. In embodiments and referring to FIG. 5, the reader may implement a method similar to “streaming” a book from the database to allow a user to start reading faster, rather than downloading and parsing the entire book file before displaying the book. The reader may provide downloads that occur in conjunction with reading, where initial views are instant. The streaming method may comprise breaking a book file 502 into smaller constituent sections 504 (either by chapter, chapter breaks, or any other logic section division). While the user is reading a section of the book, the next section of the book is passively cached 508 to provide a seamless transition from section 504 to section 504 without having to wait.

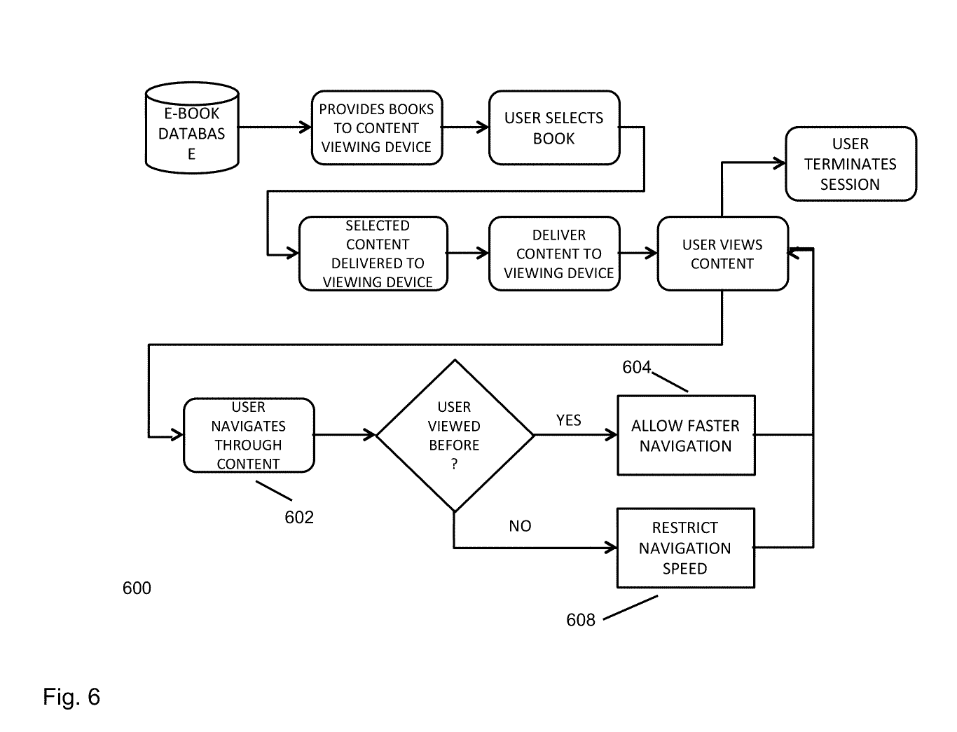

In embodiments and in FIG. 6, the systems and methods disclosed herein may comprise a method for controlling user reading speed or jumping (“scrubbing”) 600 based on tracking the extent of content previously viewed. In embodiments, the reading platform may allow users to quickly navigate, scroll, or jump 602 between sections of content. In embodiments, this navigation method, or “scrubbing” may only be activated within the range of content that has been viewed. Users may only scrub (navigate quickly 604) to the farthest point that a user has viewed while reading unviewed material at a slower pace 608. In a non-limiting example, this functionality may prevent users from jumping to the last page of a book, thereby preserving the value of the sale trigger determination function.

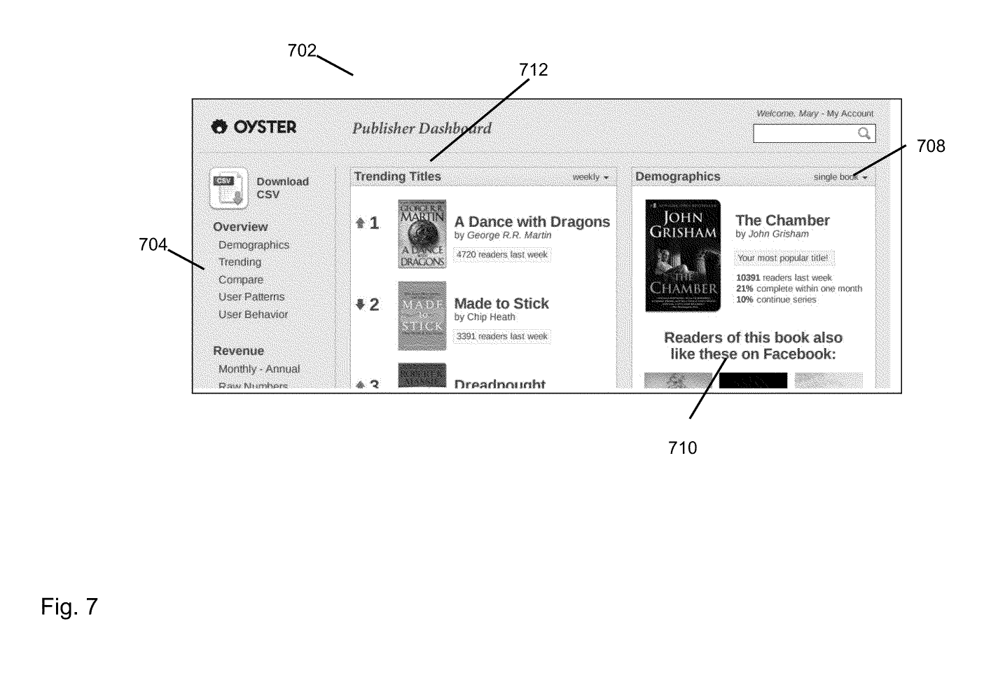

In embodiments and in FIG. 7, the systems and methods disclosed herein may comprise a publisher analytics portal. The portal may provide analytics based on in-book user activity. The portal may receive directly or derive analytic metrics from metrics or values measured or determined by the recommendation engine, lifetime value calculator, or notification engine, among others. The portal may comprise an interactive dashboard 702, where content owners may have access to the analytics 704 and view graphical representations of data. The dashboard may also provide data in other formats, such as, but not limited to, downloading data in a comma separated values format. In a non-limiting example, the information provided by the analytics may be user demographics such as, but not limited to, age, gender, location, education level, among others, where users are in a book, if users drop off at page X, what makes a user more likely to read or select a book, among others. Content owners may be allowed to see what types of books 710 are read by certain users, and may filter specific results 708 based on different filter criteria in order to make sense of data. Such filtered results may be displayed graphically and compared with other filtered results so that content owners can easily understand the information provided by the portal. In a non-limiting example, a content owner may be able to use the portal to see not only where most people stopped reading, but where people of a certain age, gender, region, etc. stopped reading. In a non-limiting example, the content owner may be able to see what is popular amongst a population, or what is trending in a favorable or unfavorable direction. In yet another non-limiting example, the content owner may be able to view the relationship between different filtered data sets. The content owner may be able to see where users are in a particular book in real time. The content owner may be able to see where users who are reading a book are physically located in real time. In embodiments, the portal may be used to break down user reading behavior based on location, gender, device type, user acquisition channel, etc. or based on reading episode (such as, but not limited to, time of day, GPS location, whether an individual is commuting). Content developers may also use the portal to see where content is most effective or determine what subject matter draws in the most users via a content trending indicator 712. The portal may also be used as a marketing tool to determine, among others, effectiveness of cover art, placement of book within a catalogue, pricing, revenue generation, etc. In embodiments, the portal may make recommendations to content owners or publishers about how to improve existing content or guidance on future content based on analytic metrics. In a non-limiting example, the portal may make a suggestion that an author re-write the third chapter if Book A if most readers stop reading Book A in the third chapter. In a similar non-limiting example, if all science fiction books with lead female characters are read avidly on the reading platform, but users still continue to search or look for more science fiction books with lead female characters, the portal may recommend that content owners generate more books of this type or acquire rights to such content. Various algorithms, statistical models, predictive models, simulations, and optimization models may be employed by the analytics portal to derive analytic results about the electronic books, and in-book reading activity, that are known to the art, such as, but not limited to, the various types described throughout this disclosure. Similarity models may account for similarity between books in the collection (based on content characteristics or on reading behavior of users within the books, among many other things) and similarity among readers (based on various demographic and psychographic factors, expressed preferences, and reading behavior within books in the collection). Grouping content and users by similarity may allow use of techniques such as collaborative filtering to generate effective recommendations for a user. An analytics portal may facilitate such grouping by allowing various factors to be used to determine what factors provide the most effective recommendations, for example. Predictive models may be used within the analytics portal to predict future behavior, such as future reading behavior of a user based on input data, such as past reading behavior of the user, past reading behavior of a user. Such models may also predict buying behavior, accounting for variables such as price, rate of abandonment, and the like. Such models may employ various forms of regression, simulation techniques, such as random walks and random forest algorithms, and Bayesian modeling techniques. The analytics portal may include various visualization techniques, such as heat maps and clustering visualization techniques, to show degrees of connection between, for example, items in the collection, readers of such items, and the like. The analytics portal may enable optimization techniques, such as use of machine learning (e.g., using a neural network), to refine and optimize actions, such as recommendations, based on feeding back a desired outcome along with historical data about various data collected within the platform.

In embodiments, the systems and methods disclosed herein may comprise a system for displaying usage based on analytics that report the individual and the aggregate behaviors of readers in a subscription based media model. The analytics may derived from a user's reader behavior to that user's interests (such as, but not limited to, a user's FACEBOOK interests or TWITTER hashtags) or non-reading behavior (such as but not limited to, GOOGLE ADWORDS search terms) and targeting new users based on these interests and behaviors. Additionally, a user's reading behavior, in particular the frequency with which they consume media, may be also be used in conjunction with how the user was referred to the media in order to target new users. In embodiments, data from third party resources relating to a book may be gathered in order to augment or facilitate the derivation of e-book related analytics. Such third party resources may be data providers such as FACEBOOK, TWITTER, LIBRARYTHING, or a user's phone contacts, among others. Furthermore, analytics may be derived based on similarities amongst a group of multiple users, including their monitored in-book data as well as other activities. Analytics may be derived for users based on the similarity of other books accessed within the database or similarities between the user's ratings or the user's reading patterns. Such analytics may be derived in conjunction with a user's behavior as reported by the third party resources. Analytics may be used to enable the collaborative filtering to identify users that share preferences for different types of third party resources as they relate to a user's reading preferences or habits. In a non-limiting example, the analytics may be used to filter results to show correlations between users that enjoy murder mystery novels and users that are active on FACEBOOK. Such analytics may be useful for marketing purposes, such as advertising new murder mystery books on the user's FACEBOOK home pages or providing exclusive invitations to a popular murder mystery author's book signing, among other uses.

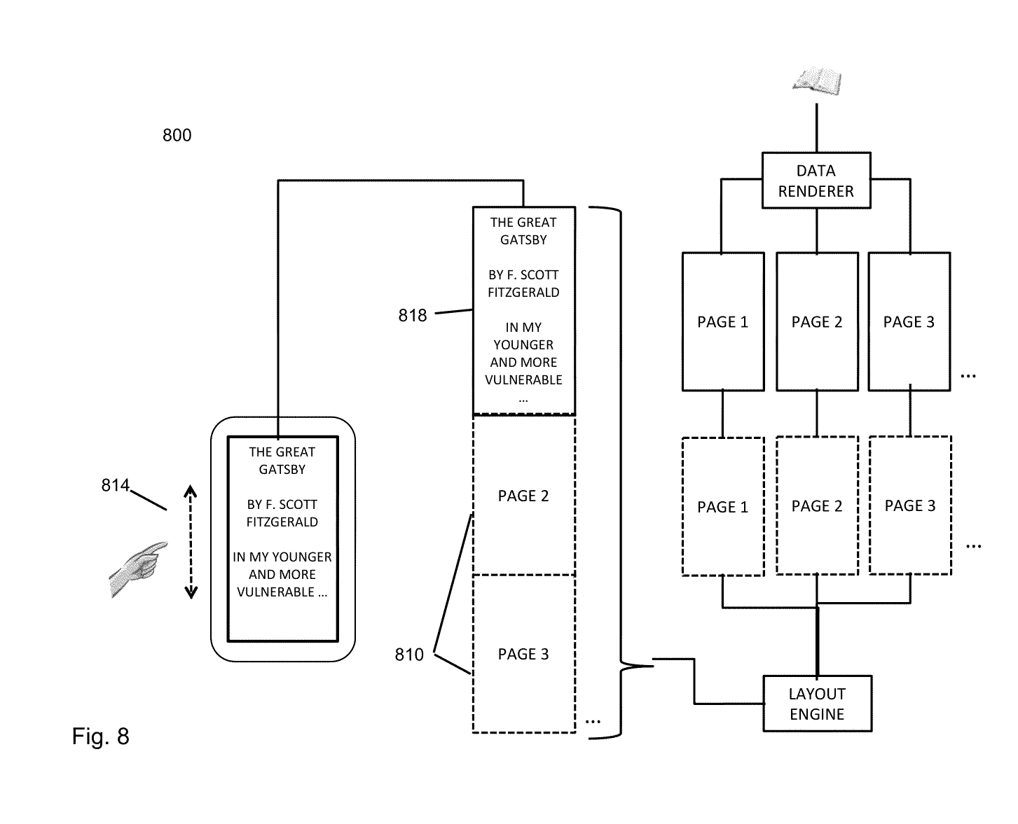

In embodiments and in FIG. 8, the systems and methods disclosed herein may comprise a reading platform native to various operating systems, including, but not limited to, iOS and Android. In embodiments, the systems and methods disclosed herein may comprise a reading platform with vertical pagination and vertical scrolling 814 based on such pagination 800. In embodiments, the platform may allow users to select text across pages. In embodiments, the reading platform may comprise an electronic media data renderer 802 (such as, but not limited to, an EPUB renderer), which is built on top of a layout engine 804 (such as, but not limited to, WebKit). In embodiments, the method of creating a vertically paginated effect may comprise separating content into smaller constituent sections 808 comprising viewing content 818, such as book text. The method may comprise graphically representing the smaller constituent sections in a non-detailed content format 810, such as a screenshot. The method may comprise using the non-detailed content format in conjunction with the viewing content in order to create the effect of vertical pagination. In a non-limiting example, each EPUB chapter may be split into horizontally laid out columns using programming methods such as, but not limited to, CSS3 columns. The effect may be hidden from the user, by making the columns the width of the screen, only showing one column at a time. The method of creating a vertically paginated effect may comprise taking a screenshot of the previous and next pages and placing them above and below the currently displayed column in the webview 812. The illusion may be maintained through the page turns by replacing the screenshot of the next page with the actual webview text once the text has come onto the screen a certain distance. The text that was previously shown in in the webview may then be replaced with a screenshot.

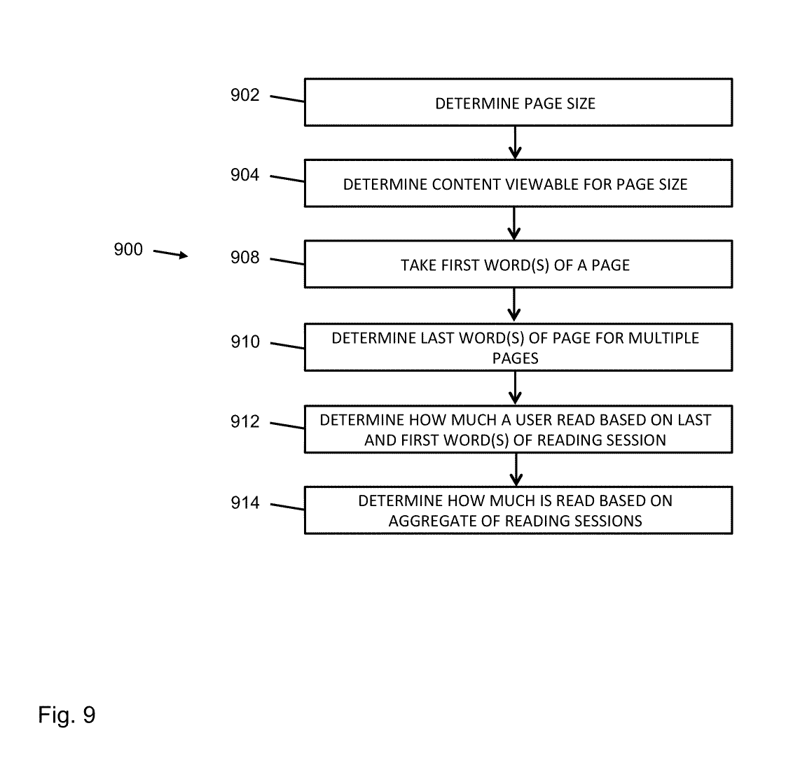

In embodiments and in FIG. 9, the reading platform may determine the extent of reading an electronic book based on device-specific user view page boundary words. Such a determination may require determining the page size and viewable content area for a specific device, such as a page displayed on a tablet device. Such a determination may be standardized, and the formula to determine this standardization may be the same for each book in the collection. In embodiments, the reading platform may comprise a view-page word method 900 to determine the extent of reading an electronic book by determining the page size of a user's content viewing device 902, then determining the amount of viewable content that can be displayed based on the determined page size 904. The platform may further determine the first word or tuple of words of a particular page 908. Additionally, the platform may determine the last word or tuple of words of multiple sequential pages 910. By determining the first word or tuple of words of a section viewed and the last word, or tuple of words of the section viewed, the platform may be able to determine the extent of reading that the user read of the electronic book during the current reading session 912. The platform may additionally determine the extent of reading of a book across multiple reading sessions, thus leading to a determination of the total amount of a book the user has read in aggregate 914. The sale trigger determination function may be implemented consistently across different devices. In a non-limiting example, a user's reading habits may be aggregated; a user who reads 2% of a book via phone, 5% via tablet, and 3% via an online web application will be accounted for 10% of the book by the sale trigger determination function.

The threshold in which a sale is triggered may be negotiated with content owners. Content that is referred from users to other users may have higher or lower sale trigger thresholds than content that is directly provided to users from content owners. The sale trigger thresholds may also vary based on other variables, such as, but not limited to, user's subscription type, device settings, demographic, among others. The recommendation and notification engines may account for sale threshold triggers when providing recommendations or notifications.

In embodiments, the systems and methods disclosed herein may comprise a method for generating a passive book list based on observed reading behavior. In embodiments, the method may comprise passively aggregating books into lists based on observed reading behavior, the data for which may come from the recommendation engine or lifetime value calculator, among others. In a non-limiting example, a book may be put into a “Read” list after reading a certain percentage or certain amount in the book. The method may comprise analyzing a reader's explicit actions as well as implicit actions, including omissions. In a non-limiting example, a book for which a user views a preview multiple times but does not buy may be put in a “To Read” list.

While only a few embodiments of the present invention have been shown and described, it will be obvious to those skilled in the art that many changes and modifications may be made thereunto without departing from the spirit and scope of the present invention as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present invention may be implemented as a method on the machine, as a system or apparatus as part of or in relation to the machine, or as a computer program product embodied in a computer readable medium executing on one or more of the machines. In embodiments, the processor may be part of an ASIC, FPGA, server, cloud server, client, network infrastructure, mobile computing platform, stationary computing platform, or other computing platform. A processor may be any kind of computational or processing device capable of performing information processing, executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes or may have no threads, programs, or codes. Any such threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. A method of determining a lifetime value of a book, comprising:
taking a reading prediction model that predicts reader reading activity for the book based on at least two of customer ratings, critic ratings, retail pricing, wholesale pricing, print pricing, and electronic pricing, the population of the reading prediction model comprising:
aggregating data from a plurality of social media sources associated with the book; and aggregating user reading activity for the book across a plurality of subscribers using an electronic book reading platform; and
using a valuation model to calculate the expected lifetime value for the book, wherein the expected lifetime value is based on at least one of the price for reading within the book, the price of the book, the reading prediction model and the cost of offering the book.

2-212. (canceled)
